(19) United States
(12) Patent Application Publication
(10) Pub. No.: US 2023/0379259 A1
(43) Pub. Date: Nov. 23, 2023

(54) CONTROLLING A TRANSMISSION OF FILES

(71) Applicant: Siemens Mobility GmbH, München (DE)

(72) Inventor: Roland Porsch, Speichersdorf (DE)

(21) Appl. No.: 18/319,633

(22) Filed: May 18, 2023

(30) Foreign Application Priority Data
May 18, 2022 (DE) 10 2022 204 927.6

(51) Int. Cl. H04L 47/24

(52) U.S. Cl. CPC H04L 47/24

(57) ABSTRACT

A method controls a transmission of files. For controlling the transmission, a type of the content of the files to be transmitted is established. Furthermore at least one attribute is assigned to the files to be transmitted on the basis of the type of their content. Subsequently the files to be transmitted are transmitted as a function of the at least one attribute.

### CROSS-REFERENCE TO RELATED APPLICATION

This application claims the priority, under 35 U.S.C. § 119, of German Patent Application DE 10 2022 204 927.6, filed May 18, 2022; the prior application is herewith incorporated by reference in its entirety.

### FIELD AND BACKGROUND OF THE INVENTION

The invention relates to a method for controlling transmission of files, a system for carrying out the method, a computer program and a computer-readable medium.

During operation of modern machines or vehicles, these create a plurality of different types of files. Such files relate, inter alia, to operating states, internal processes, maintenance information, diagnostic data, geographical positions or safety information of vehicles or machines and are of significant interest for control or supervision bodies. The files are therefore transmitted from the machines or vehicles through to the supervision or control bodies. Usually these files are transmitted in accordance with a predetermined schedule. In such cases it can be that a prespecified type of files is only transmitted once per day, another prespecified type of files on the other hand is transmitted every second or every minute for example. Moreover, files are usually transmitted in the order in which they occur. Unforeseen events, such as bottlenecks in a data transmission because of poor receive quality for example or because of an unusually high incidence of files or volumes of data can however lead to files, and thus to information, being transmitted to a control and supervision body too late. This problem has previously been resolved by a larger number of time windows or comparatively longtime windows being provided for files of a prespecified type.

### SUMMARY OF THE INVENTION

The object of the invention is to improve control of the transmission of files.

This object is achieved by a method with the features of the independent method claim. This object is furthermore achieved by an apparatus with the features of the coordinate apparatus claim and also by a system with the features of the coordinate system claim.

Moreover, the underlying object of the invention is to provide a computer program for carrying out the inventive method with the inventive apparatus and/or with the inventive system.

This object is achieved by a computer program with the features of the coordinate computer program claim and also by a computer-readable medium with the features of the coordinate claim relating to the computer-readable medium.

Advantageous developments of the present invention can be taken from dependent subclaims in each case.

The inventive method for controlling the transmission of files makes provision for establishing a type of content of files to be transmitted. On the basis of the type of content of the files, the files to be transmitted are assigned at least one attribute. Furthermore, the files to be transmitted are transmitted as a function of at least one attribute.

An attribute is to be understood in the present context as an attribute in the sense of information technology, whereby each attribute, in accordance with a type of content of a file, assigns to this file at least one feature or a characteristic and also at least one hallmark of this feature or this characteristic. A type of content of a file can for example involve media data, process data, service data, maintenance data, communication data, timetable data, vehicle data, machine data and/or safety data.

In this way a file transmission process can be controlled with little effort. In this way choosing individual files to be transmitted from a large number of files to be transmitted can be simplified and speeded up.

An advantageous development makes provision for at least some of the files to be transmitted to be assigned, as the at least one attribute, a first type of attribute. According to this measure these files are each assigned a relevance. For each file to be transmitted it can be determined in this way whether a transmission is deferred, given preference or is even to take place immediately. In this way a large number of files to be transmitted can be evaluated and/or sorted quickly and efficiently in respect of their relevance.

A further advantageous development makes provision for at least some of the files to be transmitted to be assigned, as the at least one attribute, a second type of attribute. The content of these files, which is assigned the second type of attribute, is then evaluated. According to the result of this evaluation these files are each assigned a relevance. This makes it possible to undertake a simple differentiation and fast evaluation of files, the relevance of which is dependent on their actual content. Preferably log files are assigned the second type of attribute. Predetermined events are usually logged in log files. For example, the log file can involve a safety log file, the content of which relates to digital safety. Inter alia, a number of unsuccessful or successful authentication and/or authorization attempts can be logged in said files. An audit trail log file represents a further example of a log file. Change requests are recorded in this file, regardless of whether these have been implemented or not. Evaluating the contents of such log files enables possible digital attacks on machines or vehicles or erroneous operating states of machines or vehicles to be recognized at an early stage. Depending on the result of the aforementioned evaluation, a simple sorting of log files according to relevant contents or less relevant contents can be realized.

An advantageous development furthermore makes provision for at least some of the files to be transmitted to be assigned, as the at least one attribute, a third type of attribute, in accordance with which files are assigned to a predetermined category on the basis of a type of their content. In this way a presorting of a high number of files of the same type to be transmitted or a grouping of prespecified files of different type can be realized. Files, which for example involve process data according to their type, can be assigned to corresponding subcategories. For process data the possibility exists of assigning these inter alia to subcategories that relate to a drive, an energy supply, air conditioning or further internal or external processes. Depending on given interests a fast and reliable transmission of files of a prespecified category can be brought about in this by this. Moreover, in this way a possible assignment of further attributes as a function of a category can be simplified.

An advantageous development further makes provision for at least some of the files to be transmitted to be assigned, as the at least one attribute, a fourth type of attribute. These files, for the purpose of joint transmission, are combined into at least one joint file. This makes it possible to realize an efficient and low-cost transmission of files. In this way, times for establishing a connection and also a volume of data required for this can be reduced and saved. Moreover, for example a number of authentications or, in the case of an encrypted connection, a number of key exchange processes can be reduced. A file combined in the aforementioned way can be embodied as an archive for example. A transmission of the combined file can be carried out for example as a function of a predetermined time or as a function of predeterminable events. Preferably the combined file is created with the aid of a plurality of files, which each have a comparatively small file size.

An advantageous embodiment variant makes provision for at least some of the files to which the fourth type of attribute is assigned to be assigned a first type of attribute or a second type of attribute. The file combined from individual files in accordance with the fourth type of attribute is transmitted depending on a highest relevance assigned to one of the said individual files according to the first type of attribute or the second type of attribute. Thus, a transmission of a combined file is made dependent on a highest relevance of the individual files. This makes it possible to delay the transmission of prespecified files until such time as the reason for initiating the transmission exists. Preferably files, the content of which involves diagnostic data or safety data, are transmitted in this way. These can be combined into a combined file until such time as a content of one of these said files notes a state significantly deviating from a predefined normal state. Moreover, the combined file offers the advantage of transmitting and/or evaluating corresponding files sorted in accordance with a history of events.

An advantageous development further makes provision for information relating to the files to be transmitted and an assignment of at least one attribute relating to this to be transmitted to a recipient of the files to be transmitted. Such information can involve, inter alia, the type of the content of the file, a file size, a number of data records, a number of data records per data record type, a creator of the file or an origin of the file. On the basis of information transmitted in this way it can be made possible for the recipient to adapt and/or plan their own system resources, such as storage capacity, computing power or a number of transmission channels, at an early stage to a scope of the files to be transmitted. Furthermore, it is made possible in this way for the recipient to assign their own attributes to the files to be transmitted on the basis of this information.

An advantageous embodiment variant makes provision for a file to be transmitted on the basis of the information to be read out by means of the recipient. In this way the recipient, according to their own interests, can themselves determine a time or an order of files to be transmitted.

In another advantageous development there is provision for a hallmark of a feature or of a characteristic of at least one attribute to be predetermined by a recipient of the files to be transmitted. In this way measures of assessment or evaluation can be adapted quickly and flexibly by a control or supervision body. In particular a rapid adaptation to a changed danger situation recognized by a recipient is made possible. Assignment criteria, which preferably relate to safety-relevant files, can in this way be adapted quickly to a changed danger situation. A transmission of files initially classified as less relevant can then take place by preference.

An advantageous embodiment variant makes provision for files to be transmitted at predefined intervals in accordance with the type of their content. These intervals are adapted on the basis of the first type or second type of attributes. Preferably these intervals are shortened or lengthened on the basis of the first type or second type of attribute. A transmission of files in accordance with a repeating sequence of transmission times realized in different ways can thus be controlled simply and with little effort. In the case of an occurrence of bottlenecks during the transmission of the files because of for example a restricted volume of data, a restricted bandwidth or a poor receive quality, it is made possible to continue to transmit files of high relevance and to defer a transmission of those files with a lower or no assigned relevance.

Furthermore, an advantageous development makes provision for the files to be transmitted between a mobile communication partner and a stationary communication partner. In particular the files to be transmitted are transmitted between the communication partners by means of a mobile radio network. Despite possible bottlenecks during a file transmission, because of poor reception of a restricted volume of data for example, a high level of operational security can be provided in this way.

The inventive method is carried out with the inventive apparatus.

To this end the apparatus has at least one data processing apparatus. This data processing apparatus is configured to establish the type of content of the files to be transmitted. Furthermore, this data processing apparatus is configured to assign at least one attribute to the files to be transmitted on the basis of the type of their content. Moreover the data processing apparatus is configured to transmit the files to be transmitted as a function of the at least one attribute.

The data processing apparatus can for example involve a computer, a microcontroller, a processor or another programmable hardware component. It is further conceivable for the data processing apparatus to involve a virtualized hardware resource, a computer cloud or a runtime environment with variable processing and/or storage capacities. The runtime environment is to be understood in the sense of information technology. For example, the runtime environment is configured to read in data, to write it, to transmit it and/or to manage it.

This makes it possible to control the transmission of files with little effort and in this way to realize an efficient transmission of files.

Furthermore, the inventive method is able to be carried out with the inventive system.

The system has a stationary communication partner, which is configured to communicate by means of a mobile radio network. Furthermore, the system has a mobile communication partner. This in its turn has an apparatus with at least one data processing apparatus. In this case the data processing apparatus especially involves the aforementioned data processing apparatus. Moreover, the apparatus especially involves the aforementioned inventive apparatus. The apparatus of the system is furthermore configured to transmit files to the stationary communication partner by means of the mobile radio network. Preferably the mobile communication partner involves a vehicle. Especially preferably the vehicle is embodied as a rail-bound vehicle.

The inventive system makes possible an efficient use of a data transmission capacity usually restricted in a mobile radio network, of a number of transmission channels and/or of a usable data volume. Despite a poor network coverage or a local overload of the mobile radio network, a reliable supervision and/or control of the mobile communication partners can be maintained in this way. In the case of a bottleneck in a transmission capacity a communication with the stationary communication partner can be reduced to safety-relevant files, which involve diagnostic data or process data for example. A transmission of such data as media data, which for example solely serves the purpose of an exchange of information, can be omitted in the case of bottlenecks that occur.

Furthermore, a computer program is provided in accordance with the invention that, when executed, causes the inventive apparatus to carry out the inventive method.

Moreover, the invention provides for a computer program that, when executed, causes the inventive system to carry out the inventive method.

Furthermore, a computer-readable medium is proposed. This has instructions that cause the inventive system to carry out the inventive method. As an alternative or in addition the computer-readable medium has instructions that cause the inventive apparatus to carry out the inventive method. The computer-readable medium can for example involve a CD-ROM, a DVD, USB or Flash memory or a non-physical medium, such as a data stream and/or a data medium signal.

The characteristics, features and advantages of the invention, as well as the manner in which these are achieved, are explained in greater detail in conjunction with the figures in the description given below of the versions of the invention. Where expedient the same reference characters are used in the figures for the same elements of the invention or elements that correspond to one another. The exemplary embodiment serves to explain the invention and does not restrict the invention to the combinations of features specified therein, not even with regard to functional features. Moreover all features specified in the exemplary embodiment can be considered in isolation and combined in a suitable way with the features of any given claim.

Other features which are considered as characteristic for the invention are set forth in the appended claims.

Although the invention is illustrated and described herein as embodied in a controlling a transmission of files, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic diagram of an exemplary embodiment of an inventive system, which for example has an inventive apparatus, as well as an illustration of a general example of an inventive method; and

FIG. 2 is an illustration of a specific example of the inventive method.

### DETAILED DESCRIPTION OF THE INVENTION

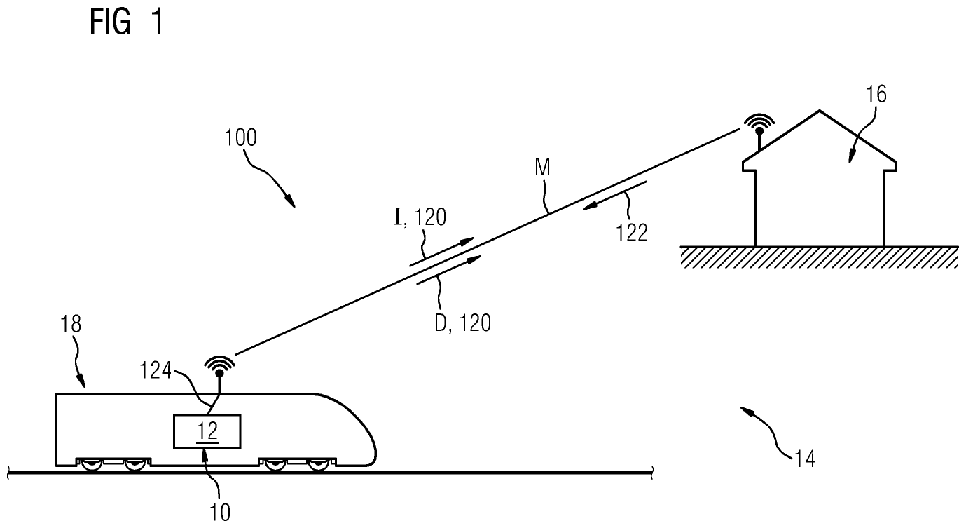

Referring now to the figures of the drawings in detail and first, particularly to FIG. 1 thereof, there is shown an exemplary embodiment of a system 14 and also an exemplary embodiment of an apparatus 10 in a schematic diagram. Furthermore, FIG. 1 illustrates a general example of a method 100 for controlling a transmission of files D.

In the exemplary example of the system 14 shown in FIG. 1 files D are transmitted 120 between a rail-bound vehicle 18 and a stationary communication partner 16. The transmission 120 of files D takes place for example by means of a mobile radio network M. During operation of the rail-bound vehicle 18 new files D of the widest range of types are constantly generated, which are to be transmitted to the stationary communication partner 16. By means of the stationary communication partner 16, which in conjunction with a communication from rail-bound vehicles is also called the land side, the rail-bound vehicle 18 is supervised inter alia as to its operating state, its geographical position or its loading. The files D to be transmitted in this case for example involve those that relate to media data, process data, service data, maintenance data, communication data, timetable data, vehicle data or other data arising during operation of the rail-bound vehicle 18.

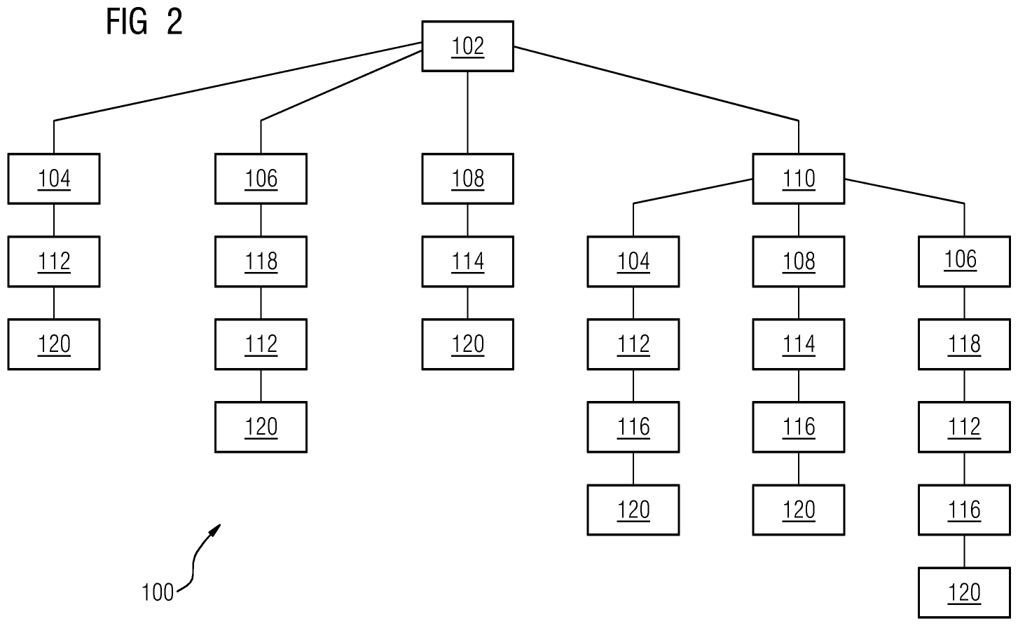

Furthermore, in the exemplary example described here by way of example, for the purposes of structuring, a transmission of these different types of files D is realized as specified by a schedule. According to this, a prespecified type of files D are each assigned at predetermined intervals to a time window, while these files D are being transmitted 120. In this way a partly repeating sequence of time windows is predetermined, within which a transmission 120 of a prespecified type of files D takes place in each case. The time intervals or time windows, depending on the type of contents of the files D, can be predetermined as different lengths. In such cases the said time intervals can amount to a few seconds, minutes or even days. In the cases of a bottleneck during a data transmission by means of the mobile radio network M however, significant delays during a transmission 120 of a prespecified type of files D can occur. In order in such cases to prevent a supervision or an operational safety of the rail-bound vehicle 18 being adversely affected, for example by time-critical information being transmitted 120 with an inappropriate delay, this transmission 120 of the files D is controlled by means of the data processing apparatus 12 of the apparatus 10. For the purposes of controlling the transmission of the files D the data processing apparatus 12 is configured to carry out the specific example of the method 100 explained in greater detail in conjunction with FIG. 2.

FIG. 2 illustrates an example of the method 100 for controlling the transmission 120 of files D. Here a type of the contents of the files D to be transmitted is initially established 102. Such a type of content can for example relate to media data, process data, service data, maintenance data, communication data, timetable data, vehicle data or other data arising during operation of the rail-bound vehicle 18. Furthermore, the files D to be transmitted are assigned 104, 106, 108, 110 at least one attribute, depending on a type of their content.

In the example of the method 100 illustrated here some of the files D to be transmitted are assigned 104 a first type of attribute. According to this a file D is assigned 112 a relevance depending on the type of its content. If for example the type of a content of the file D relates to media data or timetable data, then this file D is initially assigned 112 a lower relevance than a file D, the content of which relates to process data or diagnostic data.

Furthermore, FIG. 2 illustrates an example in which a file D to be transmitted is assigned 106 a second type of attribute as a function of an established content 102 of this file D. The content of this file D, which was assigned 106 the second type of attribute, is initially evaluated 118. Subsequently, according to a result of this evaluation 118, a relevance is assigned 112 to this file D. An assignment 106 of the second type of attribute is suitable for example for log files or diagnostic files, the relevance of which depends on their actual content. For example, unsuccessful or successful authentication and/or authorization attempts can be summarized in a safety log file. A relevance of these safety log files is in particular directed to a number of unsuccessful authentication and/or authorization attempts. In this way, by means of the second type of attribute, the safety log file can be assigned 112a relevance as a function of its content. If a number of unsuccessful authentication and/or authorization attempts that lies below a predeterminable threshold value was logged, then this file is assigned 112 no relevance or only a low relevance. If on the other hand a logged number of unsuccessful authentication and/or authorization attempts lies above the predeterminable threshold value, then this safety log file is assigned 112 a high relevance. Furthermore, it is conceivable for content of files D to which the second type of attribute is assigned 106 to be evaluated according to the second type of attribute according to a pattern 118. Such patterns can for example, in an evaluation 118 of a safety log file, point to a digital attack or in the case of process data to an immanent failure of operational components. Then, depending on such an evaluation 118, the respective file D is assigned 112 a relevance corresponding to the result.

Furthermore, the method 100 illustrated by way of example in FIG. 2 provides for assigning 108 a third type of attribute to at least one file D to be transmitted. With the aid of the third type of attribute the respective file D is assigned on the basis of a type of its contents to a prespecified category 114. For example in this way files D with different types of content can be combined into one category 114. It is conceivable in this case for the category to be able to be assigned 112 a relevance. In the example of the method 100 described here an assignment 112 of a relevance to such a category is not provided however. Using the example of the schedule described in conjunction with FIG. 1, its own time window is provided instead for such a category for example. As an alternative or in addition it is conceivable for files D with the same type of content to be divided up, in a way not illustrated any further, into various subcategories 114. Files D, which have been assigned to a prespecified subcategory 114, can additionally be assigned 104, 106 a first type or second type of attribute in the way previously described and illustrated in FIG. 2. This enables an efficient and fast differentiation of files D with the same type of content. In particular this procedure is suitable for files D that relate to process data of different processes. This enables process data to be sorted according to processes, which relate inter alia to a drive, a controller, and air conditioning system or an energy supply. According to a subcategory it is made possible in this way to assign 104, 106 to these files D further adequate first types or second types of attribute. In this way the control process can be speeded up by means of presorting of the files D.

The method 100 illustrated in FIG. 2 further makes provision for example for files D to be transmitted to be assigned 110 a fourth type of attribute. Files D, which are assigned 110 the fourth type of attribute, are combined 116 into at least one combined file for the purposes of joint transmission. In this way times for setting up a connection can be saved as well as a volume of data required for this. For example, a number of authentications for establishing a communication connection or a number of key exchange processes for an encrypted connection can be reduced. The combined file can have both files D of the same type of content and also files D of different types of content. Such a combined file can further have files D that, in the way already described above and illustrated by FIG. 2, have been assigned 104, 106, 108 a first type, second type and/or third type of attributes. Preferably log files, which each by their nature have only a very small file size, are transmitted 120 as combined files.

A transmission 120 of the combined file is governed in the exemplary embodiment described here by the attributes of the files D accepted into the combined file. If the combined file has at least one file D, has been assigned 112 a relevance according to the first type of attribute or second type of attribute, then a transmission 120 of this combined file is governed by a highest relevance assigned 112 to one of the files D to be transmitted.

The example of the method 100 described in conjunction with FIG. 2 can be realized independently of the transmission of files D based on a schedule described by way of example in conjunction with FIG. 1. For example, a transmission of files D can be controlled solely by means of the method 100 or the method 100 for controlling the transmission can be based on a type of transmission based on prespecified events or at the request of the stationary communication partner 16.

Within the framework of the present exemplary embodiment the method 100 described in conjunction with FIG. 1 is controlled in a more precise way described in conjunction with FIG. 2, in that files D are transmitted 120 as a function of the at least one assigned attribute. In this case a transmission of the files D basically takes place in accordance with the schedule previously described in conjunction with FIG. 1. Depending on a relevance assigned 112 by means of the first type or second type of attribute, there might however be a deviation from this said schedule. To this end either time intervals or an arrangement of time windows is changed 124. Furthermore, files D depending on a relevance assigned 112 to them, are either transmitted immediately 120, transmitted 120 in preference to other files D or a transmission 120 of these files D is deferred. For example, for the purposes of a preferred transmission 120 or a deferring of a transmission 120 of the files D, time intervals of the predetermined schedule are adapted 124 on the basis of the first or second type of attribute 124.

Furthermore, the example of the method 100 described in conjunction with FIG. 1 makes provision for the rail-bound vehicle 18 to transmit 120 information I by means of the data processing apparatus 12 to the stationary communication partner 16, which relates to the files D to be transmitted and to an assignment 104, 106, 108, 110 of the attribute relating thereto. In this way the stationary communication partner 16, according to its own interests, can itself determine a point in time or an order of files D to be transmitted. Preferably the stationary communication partner 16 can determine according to its own interests a point in time and/or an order of a transmission of prespecified files D independently of the aforementioned schedule. With the aid of the information I transmitted it is made possible for the stationary communication partner 16 to undertake an adaptation of a capacity of its own system resources. For example in this way, before a transmission of large files D, storage capacities, processing powers or a number of transmission channels can be adapted. Furthermore, the method 100 illustrated by way of example in FIG. 1 and FIG. 2 make provision for a version of a feature or a characteristic of the at least one attribute to be predetermined 122 by the stationary communication partner 16 or adapted by the latter. If the stationary communication partner 16 recognizes a new danger situation for example, such as a new pattern, through which a digital attack can be detected, then this partner can bring about an assignment and evaluation relating thereto of files D to be transmitted by the data processing apparatus 12.

Although the invention has been illustrated and described in greater detail by the preferred embodiments, the invention is not restricted by the disclosed examples and other variations can be derived herefrom by the person skilled in the art, without departing from the scope of protection of the invention.

1. A method for controlling a transmission of files, the method comprises the steps of:
establishing a type of content of the files to be transmitted;
assigning at least one attribute to the files to be transmitted on a basis of the type of content; and
transmitting the files to be transmitted based on the at least one attribute.

2. The method according to claim 1, which further comprises assigning at least some of the files to be transmitted a first type of attribute as the at least one attribute, in accordance with which the files are each assigned a relevance.

3. The method according to claim 2, which further comprises:
assigning at least some of the files to be transmitted a second type of attribute as the at least one attribute;
evaluating a content of a portion of the files to which the second type of attribute is assigned and, according to a result of an evaluation, the files having the second type of attribute are each assigned a relevance.

4. The method according to claim 1, which further comprises assigning at least some of the files to be transmitted a third type of attribute as the at least one attribute, in accordance with which the files are assigned on a basis of a type of contents to a prespecified category in each case.

5. The method according to claim 1, which further comprises:
assigning at least some of the files to be transmitted a fourth type of attribute as the at least one attribute; and
combining the files to which the fourth type of attribute is assigned for a purposes of a joint transmission into at least one combined file.

6. The method according to claim 5, which further comprises:
further assigning at least some of the files to which the fourth type of attribute are assigned a first type of attribute or a second type of attribute; and
transmitting the file combined from individual ones of the files in accordance with the fourth type of attribute as a function of a highest relevance assigned to one of the individual files according to the first or second type of attribute.

7. The method according to claim 1, which further comprises transmitting, information relating to the files to be transmitted and an assignment, to a recipient of the files to be transmitted.

8. The method according to claim 1, wherein a hallmark of a feature or a characteristic of the at least one attribute is predetermined by a recipient of the files to be transmitted.

9. The method according to claim 3, wherein:
the files are transmitted in accordance with a type of their content at prespecified time intervals; and
the prespecified time intervals are adapted on a basis of the first type or second type of attribute.

10. The method according to claim 1, which further comprises transmitting the files to be transmitted between a mobile communication partner and a stationary communication partner.

11. The method according to claim 1, which further comprises transmitting the files to be transmitted between a mobile communication partner and a stationary communication partner by means of a mobile radio network.

12. An apparatus, comprising:
at least one data processing apparatus configured to:
establish a type of a content of files to be transmitted;
assign at least one attribute to the files to be transmitted on a basis of the type of the content; and
transmit the files to be transmitted in dependence on the least one attribute.

13. A system, comprising:
a stationary communication partner configured to receive files by means of a mobile radio network;
a mobile communication partner containing an apparatus having at least one data processing apparatus configured to:
establish a type of a content of the files to be transmitted;
assign at least one attribute to the files to be transmitted on a basis of the type of the content; and
transmit the files to be transmitted in dependence on the least one attribute and by transmitting the files to said stationary communication partner by means of said mobile radio network.

14. The system according to claim 13, wherein said mobile communication partner is embodied as a vehicle or as a rail-bound vehicle.

15. A computer program having computer executable code stored in a non-transitory manner that, when executed, causes an apparatus according to claim 12 to execute a method which controls a transmission of files, the method comprises the steps of:
establishing a type of content of the files to be transmitted;
assigning at least one attribute to the files to be transmitted on a basis of the type of content; and
transmitting the files to be transmitted based on the at least one attribute.

16. A computer program having computer executable code stored in a non-transitory manner that, when executed, causes a system according to claim 13 to execute a method which controls a transmission of files, the method comprises the steps of:
establishing a type of content of the files to be transmitted;
assigning at least one attribute to the files to be transmitted on a basis of the type of content; and
transmitting the files to be transmitted based on the at least one attribute.

17. A non-transitory computer-readable medium having computer executable instruction when loaded on an apparatus according to claim 12, cause said apparatus to execute a method which controls a transmission of files, the method comprises the steps of:
establishing a type of content of the files to be transmitted;
assigning at least one attribute to the files to be transmitted on a basis of the type of content; and
transmitting the files to be transmitted based on the at least one attribute.
